(19) United States
(12) Patent Application Publication
(10) Pub. No.: US 2025/0378803 A1
(43) Pub. Date: Dec. 11, 2025

(54) Ergonomic Drum Cover

(71) Applicants: Dennis Klophaus, Red Oak, TX (US); Kirstyn Norris, Oklahoma City, OK (US)

(72) Inventors: Dennis Klophaus, Red Oak, TX (US); Kirstyn Norris, Oklahoma City, OK (US)

(73) Assignee: Field Cart Design Corps LLC, Red Oak, TX (US)

(21) Appl. No.: 18/739,995

(22) Filed: Jun. 11, 2024

(51) Int. Cl. G10D 13/10

(52) U.S. Cl. CPC G10D 13/10

(57) ABSTRACT

The present invention relates to an ergonomic drum cover offering comprehensive protection for drums against shock, dust, and liquid damage, while ensuring ease of installation and removal. The invention comprises an overlay with both a top and side coverage made from a flexible, water and dust-resistant material, and a protection layer featuring at least two rigid members. These rigid members are connected by a folding line, enabling the drum cover to transition between a folded state for storage and an unfolded state for use. The rigid members, crafted from either rigid or semi-rigid material, provide shock absorption, and impact resistance. This invention addresses the limitations of traditional drum covers by providing a versatile, user-friendly, and highly protective solution, suitable for a wide range of drum types and sizes, thereby significantly reducing the risk associated with the transportation and storage of drums or other musical instruments.

### FIELD OF THE DISCLOSURE

The field of the present invention pertains to the domain of ergonomic drum covers, specifically focusing on a novel drum cover design that not only offers superior protection for drums against environmental factors and physical impacts but also facilitates effortless installation and removal. This innovation represents an advancement in drum care technology, merging user-friendly features with robust protective capabilities to cater to the needs of musicians and educators alike.

### BACKGROUND OF DISCLOSURE

The present invention pertains to ergonomic drum covers, with a particular focus on a protective drum cover designed for ease of use. This invention introduces a novel folding design coupled with magnetic attachments and a dust skirt, facilitating effortless installation and removal from drums. This innovative approach addresses the need for a user-friendly solution in the drum protection market.

Traditional drum covers present significant challenges due to their bulkiness and the complexity involved in their installation. The market has historically been polarized between cumbersome drum protectors offering substantial impact protection but poor user experience, and flimsy drum covers that offer dust and water protection but fail to adequately safeguard the drums against impacts. This dichotomy leaves a gap in offerings that can provide comprehensive protection—particularly against the rigors of storage and transit—while also being user-friendly. Drums, ranging from timpani used in middle school bands to those employed by prestigious orchestras such as the Cleveland Orchestra, are frequently moved and stored, exposing them to various risks. Incidents such as the accidental dropping of objects on the drum, placing heavy items atop the drum, or other harmful practices can result in significant damage, incurring substantial repair or replacement costs.

The primary aim of this invention is to offer a solution that protects these valuable instruments against potential damage effectively. By eliminating the complexities and inefficiencies associated with traditional drum covers and protectors, this invention strives to mitigate the risks associated with the storage and transportation of drums. Through its innovative design, it ensures both ease of use and robust protection, thereby addressing a need in the market for drum safety.

### SUMMARY OF THE DISCLOSURE

The present disclosure relates to an ergonomic drum cover designed for easy installation and removal while providing shock, dust, and liquid protection to a drum. The present disclosure comprises an ergonomic drum cover comprising of an overlay including a top overlay and side overlay and a protection layer including at least two rigid members.

In one non-limiting aspect of the disclosure, the overlay is comprised of a flexible water and dust resistant material.

In another non-limiting aspect of the disclosure the protection layer is connected to the top overlay, wherein at least two rigid members are divided by a folding line that allows the ergonomic drum cover 100 to transition from an unfolded to a folded state.

In another non-limiting disclosure, the rigid members are made of any rigid or semi rigid material to provide shock protection.

In a non-limiting embodiment of the disclosure, the overlay may include a top overlay as well as a side overlay to provide further protection.

In another non limiting embodiment, protection layer may include a raised edge to elevate the top overlay and protection layer over the top/face of the drum to provide further protection.

The primary objective of the disclosure is to offer a solution that protects drums against potential damage effectively by eliminating the complexities and inefficiencies associated with traditional drum covers and protectors.

### BRIEF DESCRIPTION OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. Reference may now be made to the drawings, which illustrate various embodiments that the disclosure may take in physical form and in certain parts and arrangement of parts wherein:

FIG. 1 is a Full View of the Ergonomic Drum Cover

FIG. 2 is a Full View of the Ergonomic Drum Cover transitioning from an unfolded to a folded state.

FIG. 3 is a Full View of an alternative embodiment of the Ergonomic Drum Cover

### DETAILED DESCRIPTION OF NON-LIMITING EMBODIMENTS

A more complete understanding of the articles/devices, processes and components disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

Although the operations of exemplary embodiments of the disclosed method may be described in a particular, sequential order for convenient presentation, disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment and may be applied to any embodiment disclosed.

For the sake of simplicity, the attached figures may not show the various ways (readily discernable, based on this disclosure, by one of ordinary skill in the art) in which the disclosed system, method and apparatus can be used in combination with other systems, methods and apparatuses. Additionally, the description sometimes uses terms such as “produce” and “provide” to describe the disclosed method. These terms are abstractions of the actual operations that can be performed. The actual operations that correspond to these terms can vary depending on the particular implementation and are, based on this disclosure, readily discernible by one of ordinary skill in the art.

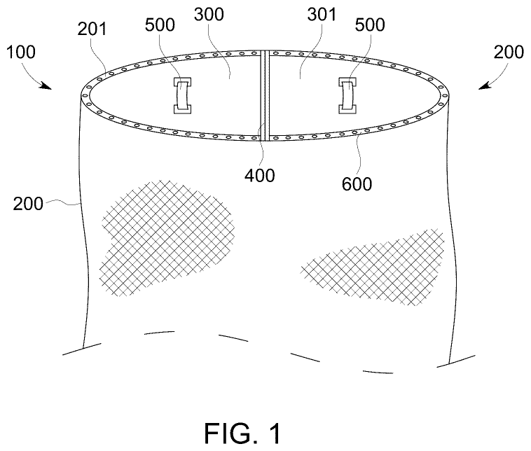

Referring now to the drawings wherein the showings are for the purpose of illustrating non-limiting embodiments of the disclosure only and not for the purpose of limiting same, FIG. 1 illustrates a non-limiting embodiment ergonomic drum cover 100 in accordance with the present disclosure. Ergonomic drum cover 100 may comprise of overlay 200, protection layer 300, and a fold line 400. Drums refer to musical instruments.

As depicted in FIG. 1 overlay 200 may comprise of top overlay 201 and side overlay 202. In an alternative non-limiting embodiment, overlay 200 may comprise of only top overlay 201 or only side overlay 202.

Further, as depicted in FIG. 1 top overlay 201 may be configured to cover at least a portion of the top of a drum spanning from greater than 0% to 100%. Overlay 200 may be constructed of any flexible material including but not limited to canvas, fiberglass, plastic, polymers, aramid fibers, and fabric. Further, overlay 200 may be constructed of any flexible material that provides protection against the elements, such as dust, liquid, oil, and sunlight.

In another alternative non-limiting embodiment, top overlay 201 and side overlay 202 may be comprised of many layers including shock absorbing materials including but not limited to rubber or expanded polystyrene to provide further protection to the drum.

In another non-limiting embodiment, ergonomic drum cover 100 may be configured to fit over other musical instruments.

In another alternative non-limiting embodiment, the interior exterior or both of overlay 200 may include a lining made of a soft material configured to protect the drum from scratching and marring. In another non-limiting embodiment this soft material may be water, dust and sunlight resistant.

In another alternative non-limiting embodiment, top overlay 201 and side overlay 202 may include a reinforcement structure comprised of any rigid material including but not limited to, plastic, polymer, metal, and wood.

In another alternative non-limiting embodiment top overlay 201 and side overlay 202 may include pockets or pouches for storing drumsticks or other small items.

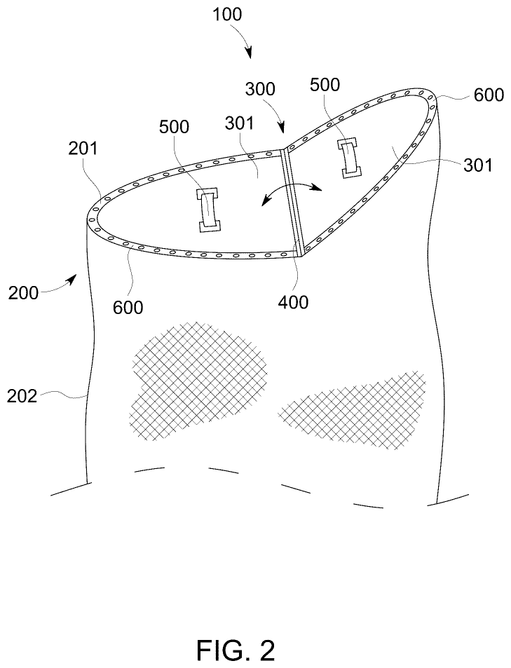

As depicted in FIG. 1, protection layer 300 may comprise of at least two rigid members 301. Also depicted in FIG. 1, protection layer 300 may be secured to top overlay 201. In another non-limiting embodiment, a protection layer similar to protection layer 300 may be attached to side overlay 202. In another non-limiting embodiment, protection layer 300 may be fully encased in overlay 200. Protection layer 300 may be attached to overlay 200 by any means including but not limited to adhesives, rivets, and hook and loop fasteners. Further, as depicted in FIG. 1-2, at least two rigid members may be divided by a fold line 400. Further, as depicted in FIG. 1-2, fold line 400 may be configured to allow ergonomic drum cover 100 to transition from an unfolded and folded state. In another non-limiting embodiment a hinge mechanism, pivoting joints, flexure bearings, and any similar mechanism may be employed to transition ergonomic drum cover 100 from an unfolded and folded state.

Further, as depicted in FIG. 1-2, ergonomic drum cover 100 may further comprise of a handle 500 attached to top overlay 201. This is not a required element, and that the device can function without it. In another non-limiting embodiment handle 500 may be attached to side overlay 202. Further, handle 500 will allow a user to easily install and remove ergonomic drum cover 100 from a drum and transition ergonomic drum cover from an unfolded to a folded state. Handle 500 can be made of any rigid or flexible material, including but not limited to canvas, fiberglass, plastic, polymers, aramid fibers, rubber metal and fabric. Further, handle 500 may be attached to overlay 200 by any means including but not limited to adhesives, rivets, and hook and loop fasteners. Additionally, handle 500 can be positioned anywhere on overlay 200 and that the positioning as shown in FIG. 1-2 should not be seen as limitation. Further, handle 500 may be constructed of any flexible material that provides protection against the elements, including the environmental impact of dust, liquid, oil resistance, and sunlight.

Further, as depicted in FIG. 1, protection layer 300 may be configured to cover at least a portion of the top of a drum spanning from greater than 0% to 100%. Further, protection layer 300 may be made of any rigid or semi rigid material including but not limited to, rubber, plastic, acrylonitrile butadiene styrene, metal, and/or wood. Protection layer 300 will protect the drum from objects being dropped or placed on the drum. As depicted in FIG. 1, at least two rigid members 301 comprise of half circles to better contour the top of a drum, but this is not a requirement and that at least two rigid members 301 may comprise of any shape. Further, as depicted in FIG. 1, at least two rigid members 301 are flat, but this is not a requirement and that they may be presented in many ways including but not limited to a corrugated pattern.

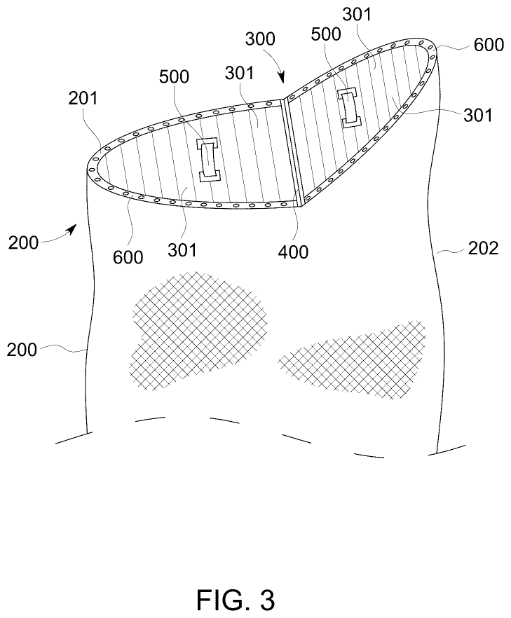

Further, FIG. 3 depicts another alternative non-limiting embodiment of ergonomic drum cover 100 wherein protection layer 300 may comprise of long panels that span the length of the top of the drum, configured to transition from and rolled up to an unrolled state.

Further, as depicted in FIG. 1-2 magnets 600 may be positioned around the perimeter of top overlay 201. This is not a requirement but an optional feature. The magnets will attract to each other when ergonomic drum cover is in a folded state securing the two sides together.

Further, any type of magnet can be employed as magnets 600 in ergonomic drum cover 100, including but not limited to neodymium magnets, ferrite magnets, samarium-cobalt magnets, and/or alnico magnets. The magnets can be positioned in any arrangement and the agreement of magnets 600 as shown in FIG. 1-2 should not be seen as a limitation.

In another alternative non-limiting embodiment magnets 600 may be disposed around the perimeter of top overlay 201. Correspondingly, ferrous studs may be embedded along the perimeter of the drum, allowing the top overlay 201 to be securely attached to the drum's perimeter through the attractive force of the magnets 600.

In another alternative non-limiting embodiment overlay 200 may comprise of one continuous piece of material.

In another alternative non-limiting embodiment, overlay 200 may comprise a separatable portion running along top overlay 201 between at least to rigid members 301 that can be sealed and unsealed by any means including but not limited to a slide fastener, magnets, hook and loop fasteners, and/or snap buttons. The separate portion could span anywhere from a small portion to the entire diameter of the top overlay 201. This will make ergonomic drum cover 100 easier to install and remove from a drum. The separatable portion may run linearly or in any other desired pattern.

In another alternative non-limiting embodiment, a separatable portion may run down the side of side overlay 202. It is not a requirement that the separated portion be sealable. The separatable portion may run linearly or in any other desired pattern. The separatable portion may be configured to be sealed and unsealed by any means including but not limited to a slide fastener, magnets, hook and loop fasteners, or snap buttons. The separate portion could span anywhere from a small portion to the entire length of the of side overlay 202. This will make ergonomic drum cover 100 easier to install and remove from a drum.

In another alternative non-limiting embodiment, side overlay 202 may include means for securing itself to a drum including but not limited to hooks, magnets, tie down strings, and/or elastic cords. This will help prevent ergonomic drum cover 100 from falling off the drum especially in transport as well as offer more comprehensive protection.

In another alternative non-limiting embodiment, the perimeter of the protection layer 300 may feature a raised edge. The raised edge would raise the protection layer above the top/head of the drum to provide further protection. Further, in another non-limiting embodiment the raised edge may be configured to only come into contact with the hoop or drum so that no portion of the cover would contact the top/head of the drum.

In another alternative non-limiting embodiment, the raised edge may include an adjustment mechanism designed to enable adjustment of the raised edge's height and width, thereby allowing the device to be adaptable and securely fitted to drums of varying sizes and dimensions. This adjustment mechanism function could be accomplished by many methods including but not limited to: a sliding mechanism integrated which may include tracks or grooves along which the raised portions slide, expanding or contracting to fit the drum's diameter and locking features, such as screws or latches to secure the adjustable parts in place once the desired size is achieved and/or a modular design where sections of the raised edge can be added or removed to fit the drum size.

A legend of components discussed herein follows:
Ergonomic Drum Cover 100
Overlay 200
Top Overlay 201
Side Overlay 202
Protection Layer 300
Rigid Member 301
Fold Line 400
Handle 500
Magnets 600

It will thus be seen that the objects set forth above, among those made apparent from the preceding description, are efficiently attained, and since certain changes may be made in the constructions set forth without departing from the spirit and scope of the disclosure, it is intended that all matter contained in the above description and shown in the accompanying drawings shall be interpreted as illustrative and not in a limiting sense. The disclosure has been described with reference to preferred and alternate embodiments. Modifications and alterations will become apparent to those skilled in the art upon reading and understanding the detailed discussion of the disclosure provided herein. This disclosure is intended to include all such modifications and alterations insofar as they come within the scope of the present disclosure. It is also to be understood that the following claims are intended to cover all of the generic and specific features of the disclosure herein described and all statements of the scope of the disclosure, which, as a matter of language, might be said to fall therebetween.

To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

What is claimed:

1. An ergonomic drum cover comprising:
an overlay configured to cover at least a portion of the top of a drum;
a protection layer secured to the overlay, wherein the protection layer is comprised of at least two rigid members;
wherein at least two rigid members are separated by at least one folding line, facilitating a transition of the rigid members between an unfolded state and a folded state;
wherein, in the unfolded state, at least two rigid members are configured to coalesce into a singular body;
wherein the singular body covers at least a portion of the top of the drum.

2. The device as described in claim 1, wherein the overlay is further comprised of a side overlay configured to cover at least a portion of the side of a drum.

3. The device as described in claim 2, wherein the side overlay includes means for securing the side overlay to the drum.

4. The device as described claim 1, wherein the device may be secured together in the folded state by magnets.

5. The device as described in claim 1, wherein the overlay is made of a flexible material that is resistant to both dust and water.

6. The device as described in claim 1, wherein at least two rigid members are fully encased in the overlay.

7. The device as described in claim 1, wherein the overlay is made of one continuous piece of material.

8. The device as described in claim 1, further comprising more than two rigid members.

9. The device as described in claim 8, wherein the rigid members comprise of long panels that span the length of the top of the drum, configured to transition from and rolled up to an unrolled state, wherein in the unrolled state, the rigid members make up the protection layer.

10. The device as described in claim 1, wherein at least two rigid members are made of a polymer, a rigid plastic, or another similar material.

11. The device as described in claim 1, wherein the overlay includes at least one handle.

12. The device as described in claim 12, wherein the handle is made of a dust, water and oil resistant material.

13. The device as described in claim 1, wherein a shock-dampening material is affixed to each of the at least two rigid members, designed to mitigate impact and vibration.

14. The device as described in claim 1, further comprising raised edges along the border of the singular body, wherein said raised edges are structured to elevate the central portion of the device above the drum surface, ensuring that only the outer edges of the device come into contact with the out rim or hoop of the drum.

15. The device as described in claim 13, further comprising a mechanism allowing adjustment of the raised edge to allow the device to be fitted to varying sizes of drums.

16. The device as described in claim 13, wherein the raised edge may be detachable.

17. An ergonomic drum cover comprising:
an overlay comprising a top portion configured to completely cover the top of a drum, and a side portion configured to cover at least a portion of the side of a drum;
a protection layer secured to the top overlay, wherein the protection layer is comprised of at least two rigid members;
wherein at least two rigid members are separated by at least one folding line, facilitating a transition of the at least two rigid members between a folded state and an unfolded state;
wherein, in the unfolded state, at least two rigid members are configured to coalesce into a singular body, thereby adapting to the contour of a drum;
wherein the singular body formed by at least two rigid members completely covers the top of the drum;
wherein magnets are situation around the perimeter of the singular body wherein the magnets are configured to securely attach the drum cover to the metal rim or hoop of a drum;

18. The device as described in claim 17, wherein at least two rigid members are made of a polymer, a rigid plastic, or another similar material.

19. The device as described in claim 17, wherein the overlay is made of a flexible material that is resistant to both dust and water.

20. The device as described in claim 17, further comprising raised edges along the perimeter of the singular body, wherein said raised edges are structured to elevate the central portion of the device above the drum surface, ensuring that only the outer edges of the device come into contact with the out rim or hoop of the drum.
